(19) United States
(12) Patent Application Publication
(10) Pub. No.: US 2014/0359250 A1
(43) Pub. Date: Dec. 4, 2014

(54) TYPE INFERENCE FOR INFERRING SCALAR/VECTOR COMPONENTS

(71) Applicant: ADVANCED MICRO DEVICES, INC., Sunnyvale, CA (US)

(72) Inventor: Benedict R. Gaster, Santa Cruz, CA (US)

(73) Assignee: ADVANCED MICRO DEVICES, INC., Sunnyvale, CA (US)

(21) Appl. No.: 13/903,469

(22) Filed: May 28, 2013

(51) Int. Cl. G06F 9/30

(52) U.S. Cl. CPC G06F 9/30036
USPC 712/3

(57) ABSTRACT

Methods and systems are provided for inferring types in a computer program. In one example, a method comprises: identifying a type of at least one expression of the computer program; and annotating the at least one expression in the computer program when the type of the at least one expression is at least one of a varying type and a uniform type.

### TECHNICAL FIELD

The technical field generally relates to methods and systems for inferring types of variables in a computer program, and more particularly to methods and systems for inferring whether a variable is uniform or varying in a computer program.

### BACKGROUND

The programming language OpenCL is an implicitly parallel programming model for graphics processing units (GPUs). The language assumes that a function (called a kernel) is executed over a three dimensional grid (referred to as an ndrange) and assumes that the grid can be sub-divided into work-groups that are collection of work-items (i.e. individual points in the grid). These collections of work-items are defined to execute in a single instruction multiple data (SIMD) fashion (i.e. they conceptually execute as a vector in lock-step). This has the implication that many loads, stores, ALU operations, and so on are implicitly presented as vector operations.

In many cases, the operations are not vector operations rather they are in fact scalar operations. This loss of knowledge of the operation type can lead to loss in performance and power. For example, in some implementations scalar control flow (e.g. a boolean expression of an if statement is the same across all lanes of the vector) allows for direct branching rather than the more expensive vector predication.

### SUMMARY OF EMBODIMENTS

Methods and systems are provided for inferring types in a computer program. In one example, a method comprises: identifying a type of at least one expression of the computer program; and annotating the at least one expression in the computer program when the type of the at least one expression is at least one of a varying type and a uniform type.

In some embodiments a computing system for inferring types of a computer program is provided. The computing system includes a processor that executes instructions. The instructions identify a type of at least one expression of the computer program; and annotate the at least one expression in the computer program when the type of the at least one expression is at least one of a varying type and a uniform type.

In some embodiments a non-transitory computer readable medium is provided. The non-transitory computer readable medium stores control logic for execution by at least one processor of a computing system. The control logic includes instructions to identify a type of at least one expression of the computer program; and annotate the at least one expression in the computer program when the type of the at least one expression is at least one of a varying type and a uniform type.

### BRIEF DESCRIPTION OF THE DRAWINGS

Advantages of the embodiments disclosed herein will be readily appreciated, as the same becomes better understood by reference to the following detailed description when considered in connection with the accompanying drawings wherein:

FIG. 1 is a simplified block diagram of a computing system that includes a type inference system according to various embodiments;

FIG. 2 is a simplified block diagram of a type inference system according to various embodiments; and

FIG. 3 is a flow diagram illustrating a method of inferring variable types according to various embodiments.

### DETAILED DESCRIPTION

The following detailed description is merely exemplary in nature and is not intended to limit application and uses. As used herein, the word “exemplary” means “serving as an example, instance, or illustration.” Thus, any embodiments described herein as “exemplary” are not necessarily to be construed as preferred or advantageous over other embodiments. All of the embodiments described herein are exemplary embodiments provided to enable persons skilled in the art to make or use the disclosed embodiments and not to limit the scope of the disclosure which is defined by the claims. Furthermore, there is no intention to be bound by any expressed or implied theory presented in the preceding technical field, background, brief summary, the following detailed description or for any particular computing system.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Finally, for the sake of brevity, conventional techniques and components related to computing systems and other functional aspects of a computing system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in the embodiments disclosed herein.

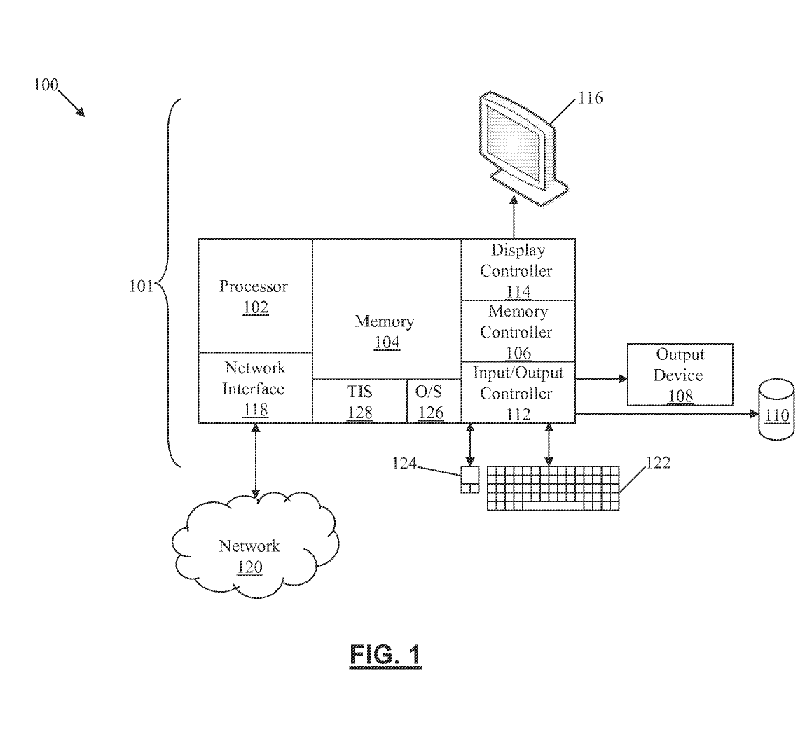

Turning now to the drawings in greater detail, it will be seen that in FIG. 1 an exemplary computing system includes a type inference system (TIS) 128 in accordance with the present disclosure. The computing system 100 is shown to include a computer 101. As can be appreciated, the computing system 100 can include any computing device, including but not limited to, a server, a workstation, a desktop computer, a laptop, a portable handheld device, or any other electronic device. For ease of the discussion, the disclosure will be discussed in the context of the computer 101.

The computer 101 is shown to include a processor 102, memory 104 coupled to a memory controller 106, one or more input and/or output (I/O) devices 108, 110 (or peripherals) that are communicatively coupled via a local input/output controller 112, and a display controller 114 coupled to a display 116. In an exemplary embodiment, a conventional keyboard 122 and mouse 124 can be coupled to the input/output controller 112. In an exemplary embodiment, the computing system 100 can further include a network interface 118 for coupling to a network 120. The network 120 transmits and receives data between the computer 101 and external systems.

As can be appreciated, practical embodiments of the computing system 100 may include other devices and components for providing additional functions and features. For example, various embodiments of the computing system include components such as additional input/output (I/O) peripherals, memory, interconnects, and memory controllers (not shown).

In various embodiments, the memory 104 stores instructions that can be executed by the processor 102. The instructions stored in memory 104 may include one or more separate programs, each of which comprises an ordered listing of executable instructions for implementing logical functions. In the example of FIG. 1, the instructions stored in the memory 104 include a suitable operating system (OS) 126. The operating system 126 essentially controls the execution of other computer programs and provides scheduling, input-output control, file and data management, memory management, and communication control and related services.

When the computer 101 is in operation, the processor 102 is configured to execute the instructions stored within the memory 104, to communicate data to and from the memory 104, and to generally control operations of the computer 101 pursuant to the instructions. The processor 102 can be any custom made or commercially available processor, a central processing unit (CPU), an auxiliary processor among several processors associated with the computer 101, a semiconductor based microprocessor (in the form of a microchip or chip set), a macroprocessor, or generally any device for executing instructions.

The processor 102 executes the instructions of a type inference system 128 of the present disclosure. In various embodiments, the type inference system 128 of the present disclosure is stored in the memory 104 (as shown), is executed from a portable storage device (e.g., CD-ROM, Diskette, FlashDrive, etc.) (not shown), and/or is run from a remote location, such as from a central server (not shown).

Generally speaking, type inference system 128 operates to automatically detect whether a type of a variable or component of a computer program is at least one of uniform (e.g., scalar) or varying (e.g., vector). The type inference system 128 further operates to annotate the components or variables with an indication of the correct type of uniform or varying.

In various embodiments, the type inference system 128 is implemented as a library function of a parallel programming language (e.g., OpenCL, or other language) that may be utilized by any computer program. The library function is processed by a compiler when compiling the computer program. The computer program may be written in any computer language that that is pre-vectorized such as, but not limited to OpenCL. For exemplary purposes, the examples discussed herein are provided in OpenCL language.

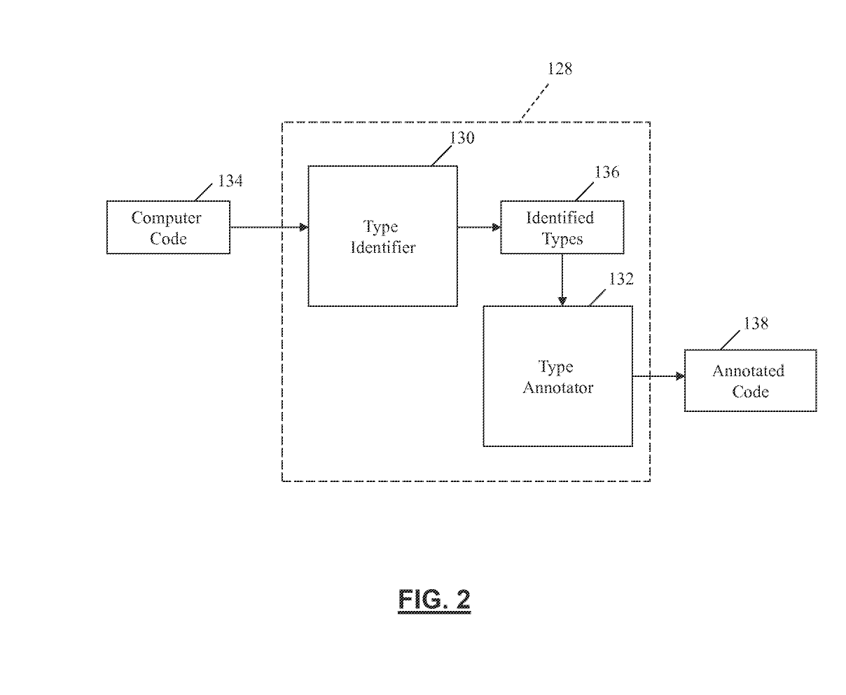

FIG. 2 illustrates a block diagram of a type inference system 128 according to various embodiments. As can be appreciated, the blocks of the block diagram are merely exemplary as the operations performed by the blocks can be combined into a single block or further partitioned into multiple blocks.

In one example, the type inference system 128 includes a type identifier 130 and a type annotator 132. The type identifier 130 processes a portion of code of the computer program 134 and determines a type of the variables in the code.

For example, the type inference system 128 evaluates the following portion of an exemplary computer program 134:

kernel void foo(global int * x, global int * y)
{

y[get_global_id(O)] = *x;

}

In the example, this kernel uses a uniform load (i.e. a scalar load that broadcasts the value) and a varying (i.e. vector) store. The type identifier 130 receives the portion of code and performs logic on that portion of code to identify the variable type to be either scalar or vector. The type identifier 130 provides the identified types to the type annotator 132.

The type annotator 132 receives the identified types 136 and the portion of code 134 and annotates the portion of code with the identified types 136. Given the example above, the annotated type is:

kernel void foo(global uniform int * uniform ′X, global uniform int *
uniform y)
{
varying_global_store(y + get_global_id(O), uniform_global_load(x));
}

Note that the original load (*operator) and store (=operator) have been translated to explicit load and stores functions that call out if they are working on scalar or vector variables. The type annotator 132 generates annotated code 138 for further processing by a compiler.

As can be appreciated, the above example is a simplest use case however, the methods and systems disclosed herein, are capable of correctly inferring a minimal typing (i.e. scalar is inferred whenever possible) for any program, including programs that make uniform use of a thread index (i.e. through get_global_id(O)). This allows the compiler to track when uniform loads and stores can be used even in complex control flows that depend on the get_global_id.

In order to identify the types and to annotate program code, the type inference system 128 uses qualified types which allow types to be predicated with a set of predicates. In general, a qualified type is written as: P=>tau, where P is a set of predicates that must hold and tau is some type that is valid under P. According to various embodiments, the type inference system 128 includes a predicate system that introduces a notion of vector width into the qualified type system, for example, by adding a new type qualifier varying that is applied to natural numbers that are a power of 2 and not 0.

For example, the width can be contained within a kind (i.e., a special type for types), for example, named NatP2.

Varying: NatP2->*,

1,2,4,8,16 . . . : NatP2 natural numbers power of 2 and not 0.

Some examples of Varying qualifiers are: Varying 64 II a wavefront wide vector, and Varying WG_SIZE II a vector with the width of the current work-group size. A special case exists in varying 1 that represents a vector of size 1 (i.e. scalar). In this case, uniform is inferred.

Two predicates are introduced to handle constraining arguments to the expect vector width and to allow uniform and wider vector widths to work together. For example, a first predicate defines the width. The first predicate includes a corresponding rule stating when the width is a valid width. The rule states a width is valid for any n that is greater than 0, a power of 2, and less than a max_work_group size supported by a particular OpenCL device shown as:

$$Width \text{:} NatP 2 -> Prop \frac{n <= max\_work \_group \_size}{P \vert Width n} [ Width ] .$$

As can be appreciated, in various embodiments n does not need to be a power of 2 and thus not enforce WG_SIZE to also be a power of 2.

A second predicate allows different vector widths to be combined in some fashion. As can be appreciated, there are many ways to combine vector widths. For exemplary purpose a few use cases are provided using propositional logic.
1. varying 1 ! varying n, which indicates that a scalar needs to be promoted to varying n (broadcast).
2. varying n ! varying 1, which indicates that a scalar should be set.
3. varying n ! varying n, two varying n operations which indicate it would stay in varying n.

The second predicate thus includes the rule:

(_!_=_): NatP2->NatP2->NatP2->Prop.

To help reduce the complexity of certain inferred types the following dependencies may be introduced that say if two of the arguments to ! are known, a missing one can be determined as shown as:

a!b=cI(a,b)->c,(a,c)->b,(b,c)->a.

The following two improvement rules allow the type inference system 128 to discharge predicates if the predicates are in these forms and match the list above:

impr{tau1!1=1}=1; and

impr{1!tau1=tau1}=tau1.

The type inference system 128 thus, produces evidence in the presence of the width predicates that is used to determine the actual vector width at runtime. This evidence is the particular vector width, a size_t, and in general will be the actual work_group_size of execution. However the vector width may be a subset of the actual work_group_Size to allow hardware vector width operations with contraction and expansion. For example, when a parallel work-group reduction is performed, which would reduce in power of twos start at work_group_size and going down to 1, each step would reduce down one div 2 in vector size. Evidence for ! is the width of the two left side arguments as shown as:

Width n|{width::size_{—}t}; and

tau1!tau2=tau3|{width1::size_{—}t,width2::size_{—}t}.

Once the predicate system is defined, get_global_id can be defined to work for any workgroup launch size:

get_global_id:forall n. Width n=>int->Varying n.

Note that a type that is polymorphic in n has been assigned and an actual value for n will be chosen at runtime or by the developer. This means that the inference system makes no assumption about the specific vector width of a given hardware implementation.

A type is assigned to an operation that adds a size_t value to a pointer. For example, addr_plus for pointers in the local address space can be typed as:

addr_plus : forall n, m, k, j . (Width n, Width m, Width k, Width j, m !
k = j) =>

local (Varying n) size_t *(Varying m)

−>Varying k size_t

−> (Varying n) size_t *(Varying j)

The type inference system 128 provides the following rule:

$$\frac{Width n Width m Width k .}{n ! m = k}$$

Based on the rule, the type of addr_plus can be simplified to be:

addr_plus: forall n, m, k, j. (Width n, m ! k = j) =>

local (Varying n) size_t *(Varying m)

−> (Varying j) size_t

−> (Varying n) size_t *(Varying j)

As can be appreciated, the type size_t can be added to other operations as the use of the addr_plus operation is merely exemplary.

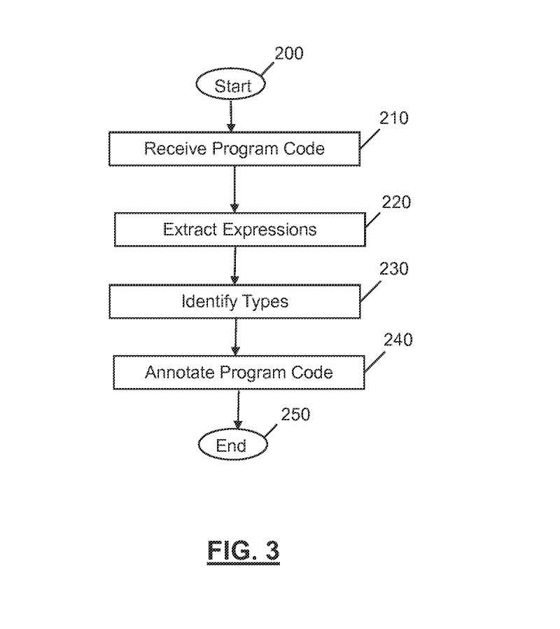

Turning now to FIG. 3, a type inference method that can be performed by the type inference system 128 of FIG. 2 is shown in accordance with exemplary embodiments. As can be appreciated in light of the disclosure, the order of operation within the method is not limited to the sequential execution as illustrated in FIG. 3, but may be performed in one or more varying orders as applicable and in accordance with the present disclosure.

In various embodiments, the method may begin at 200. The program code is received at 210. Expressions are extracted from the program code at 220. The expressions are processed based on the predicate system to determine a type at 230. Based on the type, the expressions are annotated and stored as part of the processed program code at 240. Thereafter, the method may end at 250.

An example execution of the method on exemplary program code is provided below. For example, the exemplary program code includes:

kernel void foo(global int * x, bool flag, local size_t * i) {

int y;
i[get_local_id(O)] = get_global_id(O);
if (flag) {
y = *(x+ i[flag]);
}
}

The expressions are extracted and processed. For example the expression: x+i[flag], is processed as: addr_plus(x, local_load(addr_plus(i, flag))). Based on the predicate system, the type inference system 128 infers the following types for sub-expressions:

i : local (Varying 1) size_t * (Varying 1)
flag : Varying 1 bool
x : global (Varying 1) int *Varying WG_SIZE

As addr_plus takes a size_t argument, a flag is cast to account for this:

flag:Varying 1 size_{—}t.

Providing the sub-expession: addr_plus(i,((Varying 1)size_t) flag), which gives: n=l, m=WG SIZE, k=1 and m! k=j, which can be simplified to WG_SIZE! 1=j, the type inference system 128 can deduce j such that: j=1. Thus, a result type is provided of:

(Varying 1)size_{—}t*(Varying 1).

At this point, even though values get_group_id(O) were stored within i[get_local_id(O)], a uniform value can be used to calculate the address, and the resulting value is uniform.

Given that the type inference system 128 now has a type for the sub-expression: addr_plus(i,flag), it is straight-forward to deduce that local_load(addr_plus(i, flag)) has the type: (Varying 1)size_t.

The same process as above can be applied to deduce the type for:

addr_plus(x,local_load(addr_plus(i,flag))).

Given:

local_load(addr_plus(i,flag)):Varying 1 size_{—}t and

x:global(Varying 1)int*Varying WG_SIZE,

the type inference system 128 can deduce: n=1, m=WG SIZE, and k=1 and m ! k=j, which can be simplified to WG_SIZE ! 1=j. The type inference system 128 can further deduce j such that: j=1. As a consequence, the return type is:

(Varying 1)sizt_{—}t*(Varying 1).

Now, rewriting the original expression: *(x+i[flag]) and taking into account the deduced types the type inference system 128 provides:

global_load(global_addr_plus(x,uniform_local_load(local_addr_plus(i,((Varying

1)size_{—}t)flag))))).

As already provided, the global_addr_plus has the return type:

(Varying 1)sizt_{—}t*(Varying 1).

Thus, it is straightforward to deduce that global_load is itself uniform. Thus, the rewritten expression provides:

uniform_global_load(global_addr_plus(x,uniform_local_load(local_addr_{—}

plus{i,((Varying 1)size_{—}t)flag))))).

The method illustrated in FIG. 3 may be governed by instructions that are stored in a non-transitory computer readable storage medium and that are executed by at least one processor of the computing system 100. Each of the operations shown in FIG. 3 may correspond to instructions stored in a non-transitory computer memory or computer readable storage medium. In various embodiments, the non-transitory computer readable storage medium includes a magnetic or optical disk storage device, solid state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

While at least one exemplary embodiment has been presented in the foregoing detailed description of the disclosed embodiments, it should be appreciated that a vast number of variations exist. It should also be appreciated that the exemplary embodiment or exemplary embodiments are only examples, and are not intended to limit the scope, applicability, or configuration of the disclosed embodiments in any way. Rather, the foregoing detailed description will provide those skilled in the art with a convenient road map for implementing the disclosed embodiments, it being understood that various changes may be made in the function and arrangement of elements of the disclosed embodiments without departing from the scope of the disclosed embodiments as set forth in the appended claims and their legal equivalents.

What is claimed is:

1. A method for inferring types of a computer program, comprising:
identifying a type of at least one expression of the computer program; and
annotating the at least one expression in the computer program when the type of the at least one expression is at least one of a varying type and a uniform type.

2. The method of claim 1, wherein the identifying the type is based on a predicate system that is based on variable width.

3. The method of claim 1, wherein the annotating the at least one expression comprises annotating at least one of a load and a store operation of the expression based on the determination of the at least one of the varying type and the uniform type.

4. The method of claim 1, wherein the computer program is provided in a pre-vectorized programming language.

5. The method of claim 4, wherein the identifying the type comprises:
determining that the at least one expression is a scaler type; and
identifying the at least one expression as a uniform type.

6. The method of claim 4, wherein the identifying the type comprises:
determining that the at least one expression is a vector type; and
identifying that the at least one expression as a varying type.

7. A computing system for inferring types of a computer program, comprising:
a processor that executes instructions, wherein the instructions:
identify a type of at least one expression of the computer program; and
annotate the at least one expression in the computer program when the type of the at least one expression is at least one of a varying type and a uniform type.

8. The computing system of claim 7, wherein the instructions identify the type based on a predicate system that is based on variable width.

9. The computing system of claim 7, wherein the instructions annotate the at least one expression by annotating at least one of a load and a store operation of the expression based on a determination of the at least one of the varying type and the uniform type.

10. The computing system of claim 8, wherein the computer program is provided in a pre-vectorized programming language.

11. The computing system of claim 10, wherein the instructions identify the type by determining that the at least one expression is a scaler type, and identifying the at least one expression as a uniform type.

12. The computing system of claim 10, wherein the instructions identify the type by determining that the at least one expression is a vector type, and identifying that the at least one expression as a varying type.

13. A non-transitory computer readable medium storing control logic for execution by at least one processor of a computing system, the control logic comprising instructions to:
identify a type of at least one expression of the computer program; and
annotate the at least one expression in the computer program when the type of the at least one expression is at least one of a varying type and a uniform type.

14. The non-transitory computer readable medium of claim 13, wherein the instructions identify the type based on a predicate system that is based on variable width.

15. The non-transitory computer readable medium of claim 13, wherein the instructions annotate the at least one expression by annotating at least one of a load and a store operation of the expression based on a determination of the at least one of the varying type and the uniform type.

16. The non-transitory computer readable medium of claim 13, wherein the computer program is provided in a pre-vectorized programming language.

17. The non-transitory computer readable medium of claim 16, wherein the instructions identify the type by determining that the at least one expression is a scaler type, and identifying the at least one expression as a uniform type.

18. The non-transitory computer readable medium of claim 16, wherein the instructions identify the type by determining that the at least one expression is a vector type, and identifying that the at least one expression as a varying type.
